(19) United States
(12) Patent Application Publication
(10) Pub. No.: US 2024/0161025 A1
(43) Pub. Date: May 16, 2024

(54) Exploratory Orchestration of Mixed Methodology Incident Remediation Workflows

(71) Applicant: International Business Machines Corporation, Armonk, NY (US)

(72) Inventors: Sampath Dechu, Acton, MA (US); Kushal Mukherjee, New Delhi (IN); Jayachandu Bandlamudi, Guntur (IN); Naveen Eravimangalath Purushothaman, Thrissur (IN)

(21) Appl. No.: 17/984,778

(22) Filed: Nov. 10, 2022

(51) Int. Cl. G06Q 10/06

(52) U.S. Cl. CPC G06Q 10/063112; G06Q 10/063114

(57) ABSTRACT

Mechanisms are provided for generating, executing, orchestrating, and monitoring an information technology (IT) incident remediation task workflow. An IT incident notification is received and a knowledge data structure associated with an IT resource corresponding to the IT incident is retrieved. IT remediation task(s) are extracted from the knowledge data structure and correlated with skills in a plurality of predetermined skills. Automated tools are correlated with corresponding skills in the plurality of predetermined skills. An IT incident remediation task workflow is generated based on a matching of skills associated with the IT remediation tasks and automation tools. The generated IT incident remediation task workflow is automatically executed on the at least one IT resource.

### BACKGROUND

The present application relates generally to an improved data processing apparatus and method and more specifically to an improved computing tool and improved computing tool operations/functionality for automatically performing exploratory orchestration of mixed methodology incident remediation workflows.

To stay competitive in the modern information technology (IT) environment, where enterprises must provide valuable digital experiences to their customers and employees to be successful, enterprises have transitioned to a site reliability engineering (SRE) operating model. The SRE operating model involves SRE teams that focus on facing challenges to maintain IT infrastructures stable and reliable. This task is daunting in the ever increasing complexity of IT infrastructures and the sheer volume of data coming from a myriad of different IT systems, monitoring tools, and the like.

To truly be successful, SRE teams need to be ahead of application and IT infrastructure outages and resolve incidents before they impact users. However, may SRE teams are still blinded by unforeseen or even repeated problems in their IT infrastructures, as these SRE teams become overwhelmed by noise while they detect, isolate, and diagnose incidents and seek to resolve them. SRE teams may struggle to quickly identify resolution actions for IT incidents as they have to sift through multiple data sources, such as metrics, topology, events, logs, tickets, alerts, and chat conversations.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises receiving an information technology (IT) incident notification specifying an IT incident and retrieving at least one knowledge data structure associated with at least one IT resource, of an IT infrastructure, corresponding to the IT incident. The method further comprises extracting, from the at least one knowledge data structure, one or more IT remediation tasks for handling the IT incident. In addition, the method comprises generating an IT remediation task skill set at least by identifying one or more skills in a plurality of predetermined skills that are associated with the one or more IT remediation tasks. The method further comprises executing at least one first correlation operation that correlates at least one automated tool with at least one corresponding first skill in the IT remediation task skill set. In addition, the method comprises generating an IT incident remediation task workflow, comprising the one or more IT remediation tasks, based on the IT remediation task skill set and results of the at least one first correlation. Moreover, the method comprises automatically executing the generated IT incident remediation task workflow on the at least one IT resource.

In some illustrative embodiments, the method further comprises executing a second correlation operation that correlates at least one site reliability engineer with at least one corresponding second skill in the IT remediation task skill set. In these embodiments, the IT incident remediation task workflow is further generated based on the results of the second correlation operation as well. This allows for a mixed methodology IT incident remediation task workflow in which some tasks are executed by automated tools while others may be executed by site reliability engineers.

In some illustrative embodiments, executing the first correlation operation comprises identifying one or more skill gaps, wherein a skill gap is a skill in the IT remediation task skill set for which there is no automated tool that provides that skill. This allows the mechanism to identify where there are no automated tools to invoke for performing an IT remediation task such that a fallback IT remediation task or site reliability engineer (SRE) or SRE team may be utilized. Thus, in some illustrative embodiments, the at least one second skill is a skill associated with a skill gap, and the second correlation operation is only performed with regard to skills associated with skill gaps.

In some illustrative embodiments, the method further comprises, for each of the one or more skill gaps: determining for a corresponding IT remediation task associated with the skill corresponding to the skill gap, whether a fallback IT remediation tasks is available that could be performed instead of that corresponding IT remediation task; in response to determining that a fallback IT remediation task is available that could be performed instead of that corresponding IT remediation task, determining if an automated tool is available that provides a skill needed to perform the fallback IT remediation task; and in response to determining that an automated tool is available that provides a skill needed to perform the fallback IT remediation task, replacing the corresponding IT remediation task with the fallback IT remediation task in the IT remediation task workflow and selecting the automated tool to perform the fallback IT remediation task in the IT remediation task workflow. Thus, these illustrative embodiments may automatically look for fallback IT remediation tasks for which automation tools are available to provide the needed skills and then modify the IT remediation task workflow to include these fallback IT remediation tasks instead of the originally IT remediation tasks in the workflow. Hence, the IT remediation task workflow may be modified to maximize automated tool performed IT remediation tasks.

In some illustrative embodiments, in response to an automated tool not being available that provides the skill needed to perform the fallback IT remediation task, a lookup operation is performed in a site reliability engineer data structure based on the skill needed to perform the fallback IT remediation task and, in response to identifying an entry for a site reliability engineer or site reliability engineering team, in the site reliability engineer data structure, that provides the skill needed to perform the fallback IT remediation task, replacing the corresponding IT remediation task with the fallback IT remediation task in the IT remediation task workflow and selecting the site reliability engineer or site reliability engineering team to perform the fallback IT remediation task in the IT remediation task workflow. Thus, with the mechanisms of these illustrative embodiments, where an automated tool is not found to provide the necessary skills, and there are no fallback IT remediation tasks whose skills are provided by automated tools, SREs/SRE teams may be assigned to perform the fallback IT remediation task. In this way, a mixed methodology IT remediation task workflow may be generated.

In some illustrative embodiments, retrieving the at least one knowledge data structure comprises identifying, from an IT topology graph data structure, the at least one IT resource, wherein the IT topology graph data structure comprises nodes corresponding to IT resources and edges representing dependencies between IT resources, and wherein the identification of the at least one IT resource comprises evaluating dependencies between IT resources associated with an IT resource corresponding to the IT incident notification based on the IT topology graph data structure. Thus, the mechanisms of the illustrative embodiments may automatically identify which IT resources are affected by the IT incident based on dependencies and the corresponding knowledge data structures may be accessed to determine the IT incident remediation tasks that are to be performed.

In some illustrative embodiments, the at least one knowledge data structure comprises at least one natural language document, and wherein extracting one or more IT remediation tasks for handling the IT incident comprises: executing natural language processing configured with an IT remediation task vocabulary of terms/phrases indicative of IT incidents on the at least one knowledge data structure; and identifying an ordered sequence of IT remediation tasks based on the natural language processing of the at least one knowledge data structure. Moreover, in some illustrative embodiments, the at least one natural language document comprises, for each of the at least one IT resource, a corresponding knowledge article having portions describing IT incidents and portions describing IT remediation tasks for the IT incidents, and wherein the natural language processing comprises a sentence similarity processing between the IT remediation task vocabulary and the portions of the knowledge article. Thus, these illustrative embodiments are able to identify IT remediation tasks from natural language content, and in some cases this natural language content may be the knowledge articles document incidences and corresponding remediation tasks associated with particular IT resources.

In some illustrative embodiments, executing the first correlation operation comprises performing natural language processing of automated tool descriptions in an automated tool catalog data structure to identify skills associated with automated tools and performing a sentence similarity analysis of the automated tool descriptions with the skills in the IT remediation task skill set. Furthermore, in some illustrative embodiments, executing the second correlation operation comprises processing one or more site reliability engineer (SRE) data structures specifying skills associated with different SREs or SRE teams and matching skills associated with different SREs or SRE teams with the IT remediation task skill set. Thus, correlations between skills required for performing IT remediation tasks, skills provided by automated tools, and skills provided by SREs/SRE teams are made possible.

In some illustrative embodiments, the method further comprises generating an IT remediation tasks knowledge graph data structure in which nodes represent IT incidents and IT remediation tasks corresponding to the IT incidents, and wherein edges link selected one of the IT remediation tasks to corresponding IT incidents with which the IT remediation tasks are associated. In some illustrative embodiments, identifying one or more skills in a plurality of predetermined skills that are associated with the one or more IT remediation tasks comprises: identifying a subset of nodes in the IT remediation tasks knowledge graph data structure that correspond to the IT incident specified in the IT incident notification; and identifying the one or more skills based on characteristics of the subset of nodes in the IT remediation tasks knowledge graph data structure. Thus, the IT remediation tasks knowledge graph data structure provides a mechanism by which correlations between IT remediation tasks and IT incidences is made possible and searchable.

In some illustrative embodiments, the method further comprises classifying the one or more skills in the plurality of predetermined skills as being one of a plurality of predetermined skill types, wherein the skill types comprise an action skill type, a monitor skill type, a fallback skill type, and a rollback skill type. Moreover, with these illustrative embodiments, generating an IT incident remediation task workflow may comprise selecting, for each IT incident remediation task in the IT incident remediation task workflow, a corresponding automated tool or site reliability engineer based on a trained machine learning computer model that scores the at least one automated tool and at least one site reliability engineers based on results of the first correlation operation, results of the second correlation operation, a classification of skills associated with the at least one automated tool, and a classification of skills associated with the at least one site reliability engineer. Thus, the classification of skills may be used as a basis for selecting an automated tool and/or SRE/SRE team to perform the corresponding IT incident remediation task.

In some illustrative embodiments, the trained machine learning computer model scores the at least one automated tool and the at least one site reliability engineer based on a degree of matching of skills associated with the at least one automated tool and skills associated with the at least one site reliability engineer, and based on whether or not the at least one automated tool and the at least one site reliability engineer has a rollback skill or a fallback skill. Thus, in these illustrative embodiments, the best option for performing an IT incident remediation task may not be the closest matching of skills, but other factors may also be included in the scoring, including whether the automated tool or SRE has a corresponding rollback skill or fallback skill.

In some illustrative embodiments, selecting the corresponding automated tool or site reliability engineer further comprises performing an exploratory orchestration operation at least by identifying, for one or more of the IT remediation tasks in the IT incident remediation task workflow, one or more fallback tasks based on the classification of the one or more skills in the plurality of predetermined skills, and generating alternative IT incident remediation task workflows comprising the one or more fallback tasks. Thus, these illustrative embodiments are able to evaluate alternative IT incident remediation task workflows that may be more appropriate options for implementation or may be used in the case of a failure of an IT incident remediation task, for example.

In some illustrative embodiments, generating the IT incident remediation task workflow comprises executing a trained machine learning computer tool on input features corresponding to the IT remediation task skill set, characteristics of the automation tools from an automation tools catalog, characteristics of site reliability engineers or site reliability engineering teams from a site reliability engineering data structure, the correspondence of the at least one automated tool with the at least one corresponding first skill, and the correspondence of and the at least one site reliability engineer with the at least one corresponding second skill to score each automation tool and site reliability engineer or site reliability engineering team for performing each IT remediation task in the IT remediation task workflow. Thus, a complex analysis of various features and factors may be performed by a trained machine learning computer tool that can evaluate complex patterns of input features and generate an optimized selection of IT incident remediation tasks for an IT incident remediation task workflow.

In some illustrative embodiments, the method further comprises selecting, for each IT remediation task in the IT remediation task workflow, at least one of an automation tool, site reliability engineer, or site reliability engineering team to perform the IT remediation task based on the scores. Thus, this selection allows for the relatively best combination of automated tools and SRE/SRE teams to be utilized to resolve an IT incident by performing the IT incident remediation task workflow.

In some illustrative embodiments, the IT incident remediation task workflow comprises at least one first IT incident remediation task that has an associated automated tool assigned to perform the at least one first IT incident remediation task, and at least one second IT remediation task that has an associated site reliability engineer or site reliability engineering team assigned to perform the at least one second IT incident remediation task. Moreover, in some illustrative embodiments, automatically executing the generated IT incident remediation task workflow on the at least one IT resource comprises: for each first IT incident remediation task, automatically invoking the assigned automated tool to execute operations to perform the first IT incident remediation task and awaiting an automated response indicating completion of the first IT incident remediation task by the assigned automated tool; and for each second IT incident remediation task, automatically transmitting an electronic communication to a computing device associated with the site reliability engineer or site reliability engineering team and awaiting a responsive communication from the computing device indicating completion of the second IT incident remediation task by the site reliability engineer or site reliability engineering team. Thus, these illustrative embodiments provide mechanisms to automatically orchestrate the performance of the automatically generated IT incident remediation task workflow where the tasks of the workflow involve a mixture of automated tools and SRE/SRE teams performing their corresponding tasks.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram illustrating the primary operational components of an exploratory orchestration computing tool for information technology (IT) incident remediation workflows in accordance with one illustrative embodiment;

FIG. 2 is a flow diagram illustrating a process for IT incident remediation task workflow exploration in accordance with one illustrative embodiment;

FIG. 3 is a flowchart outlining an example operation for performing IT incident remediation task workflow exploration in accordance with one illustrative embodiment; and

FIG. 4 is an example diagram of a distributed data processing system environment in which aspects of the illustrative embodiments may be implemented and at least some of the computer code involved in performing the inventive methods may be executed.

### DETAILED DESCRIPTION

Remediation of information technology (IT) incidents in many cases may require a combination of human expert actions and the execution of one or more specialized computing tools in a specific order to address the IT incident and ensure stable and reliable operation of the IT infrastructure, which may be comprised of applications executing on computing resources, as well as the computing resources, e.g., computing devices, storage devices, network communication infrastructure, and the like. However, determining what tasks are needed for addressing an IT incident, what order the tasks need to be performed in, what skills are required to perform the tasks, what human/computing tool resources provide the required skills, and then orchestrating the performance of these tasks in accordance with these determinations, is a complex endeavor.

Artificial intelligence for IT operations (AIOps) is an area devoted to integrating artificial intelligence into IT operation management where various monitoring tools are utilized to gather data from monitored applications, systems, and components of an IT infrastructure, and where dashboards are presented to authorized personnel, such as site reliability engineering (SRE) team members. The information presented via the dashboards may include various conditions of the IT infrastructure, alerts of IT incidents, and the like. The AIOps tools provide insights generated by AI and machine learning mechanisms to augment such information presented in dashboards. While such AIOps tools provide a significant aid to human SRE team members, these AIOps tools do not have the capability of performing exploratory orchestration of IT incident remediation workflows, especially to automatically generate IT incident remediation workflows composed of mixed methodologies for performing the tasks of the workflow, e.g., workflows having human performed tasks and automated computing tool performed tasks, based on an intelligent consideration of the skills required to perform the various tasks. In particular, such AIOps systems do not have the capability to identify skill gaps in a workflow, where automated computing tools do not have the skills to perform a task, and determine which human resources may be available to provide those skills and perform the tasks, and then orchestrate the performance of the mixed methodology workflow.

The illustrative embodiments provide an improved computing tool and improved computing tool operations/functionality that specifically performs exploratory orchestration of information technology (IT) incident remediation workflows. Moreover, the illustrative embodiments provide specific mechanisms to perform such exploratory orchestration with regard to mixed methodology IT incident remediation workflows that are composed of human performed, e.g., site reliability engineering (SRE) team performed, and automated computing tool performed tasks. The illustrative embodiments leverage various sources of data regarding the IT topology, SRE remediation tasks, automation tools, as well as skills provided by the SREs and automation tools and dependencies between skills, etc., to automatically compose IT incident remediation workflows for IT incidents and automatically orchestrate the performance of the various tasks within the automatically composed workflows. The composing of the workflows take into consideration the fallback/rollback skills required for automation tools that may fail to perform their tasks successfully. The composing of the workflows determines gaps in skill availability from automated computing tools, and automatically provides for specific SRE intervention ordered in accordance with automated computing tool performance of other tasks in the workflow. In some illustrative embodiments, the mechanisms of the illustrative embodiments explore remediation skills and different combinations of tasks for workflows that are not observed from historic logs or the IT topology data.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described above, the illustrative embodiments of the present invention are specifically directed to an improved computing tool that automatically performs exploratory orchestration of IT incident remediation workflows, which may be mixed methodology workflows comprising human performed tasks and automated computing tool performed tasks ordered to accomplish remediation of an IT incident. The illustrative embodiments provide an improved computing tool that generates a sequence of remediation tasks, each task being associated with one or more required skills. These skills are generally categorized into action skills, monitoring skills, rollback skills, and fallback skills. Action skills are skills regarding the affirmative performance of actions to modify a state of an application, computing device, storage device, network resource, or the like, so as to progress towards remediation of an IT incident, e.g., installing an application component, adding additional storage devices, changing an allocation of processor or memory resources, increasing an allocation of available bandwidth of network connections, or any other action taken by a human being or automated computing tool to change a state of an IT infrastructure resource, where the IT infrastructure is represented in one or more data structures that set forth the IT topology.

Monitoring skills are skills regarding monitoring whether an action, corresponding to an action skill, was performed correctly or not. For example, if the action is installing a Java application, the action skill may be a skill for installing applications, and the monitoring skill may be a skill for monitoring the installation of applications to ensure that the applications are installed correctly, e.g., that the Java application is installed such that it is functioning correctly with regard to stability and reliability.

A rollback skill is a skill for rolling back changes made by execution of an action, e.g., a skill for performing an “undo” operation on changes made by an action using an action skill. For example, if the monitoring skill based task determines that an action skill based task, such as installing the Java application, was performed incorrectly, then a rollback skill may be required for a rollback task to reset the affected system(s) or IT resources to a previous state prior to the action skill based task being performed.

A fallback skill is a skill for performing an alternative action to address a failure of an action skill task being accomplished correctly. That is, rather than rolling back changes, alternative actions may be taken to address the failure of a task that may accomplish a similar action result, alternative satisfactory result, or otherwise address the failure in some specified way, instead of performing the action skill based task. For example, if the Java application is not installed correctly by the action skill based task, then fallback skill based task may be performed to do something instead of installing the Java application.

The tasks and their associated skills may be determined from various sources of information including IT topology information specifying the various applications, computing devices, storage devices network resources, and the like, knowledge articles and data structures describing IT incidents, remediation actions, and the like, and automation tool catalog databases specifying characteristics of automated computing tools used to perform various tasks within an IT infrastructure. For example, an IT topology data structure may be provided that identifies the various IT resources in the IT infrastructure, their dependencies, which resources communicate with or operate with other resources, and the like. For example, the IT topology data structure may comprise a directed graph data structure in which nodes represent IT resources, virtual and/or physical, and edges represent data flows or data communication connections between these IT resources.

These nodes and edges of the IT topology data structure may have associated characteristics that are indicative of the types of skills required to address IT incidents associated with those IT resources. These characteristics may take many different forms depending on the particular type of IT resource and the particular correlations between characteristics and skills with which the mechanisms of the illustrative embodiments are configured. For example, the IT topology data structure may specify various applications which are connected to each other. The processing of the IT topology data structure to extract the characteristics of the IT topology may involve extracting application level data, such as application name, run time information, configurations, and the like. This information, such as the configuration information, specifies the inputs and outputs of each application which provides a basis for identifying the dependencies between various applications. For example, if an IT issue occurs, information is available about the application which caused the issue and for that specific application all the dependences and the order of execution of the application relative to other applications.

The knowledge articles and/or knowledge data structures may comprise natural language documents, such as SRE/SRE team reports, electronic communications, online forums, trade publications, user feedback documents, social networking posts, and the like. These knowledge articles and/or knowledge data structures may have associated metadata which may have tags and values that specify metadata content indicative of IT incidents, remediation actions, and the like, and may also be parsed and processed to extract features of such IT incidents and remediation actions. For natural language documents, natural language processing, configured to extract IT incident information and remediation action information from natural language content, may be utilized to extract the information needed to identify remediation actions (tasks) for different IT incidents. For example, the natural language processing algorithms used to extract IT incidents and action data may be configured with specific vocabularies of terms/phrases indicative of IT incidents, e.g., terms/phrases indicative of erroneous operations, known faults, and the like, and actions, such as remediation actions, results of remediation actions, and the like. In some illustrative embodiments, the natural language processing (NLP) algorithms may parse the metadata of the knowledge articles and/or knowledge data structures with regard to tags, error codes, etc. to extract IT incident information.

As an example, in some illustrative embodiments, each IT resource, e.g., each application, has an associated knowledge article which comprises sections for specifying application related issues and corresponding remediation actions. When an IT incident occurs, at first the required knowledge article is identified based on an identifier of the application(s) with which the IT incident occurred. Then, sentence similarity measures may be used to match the IT incident description with the descriptions of IT incidents in the knowledge article and extract the corresponding remediation actions for that IT incident. Sentence similarity is a process that models text as vectors (embeddings), which may capture semantic information, and determines a distance measure, e.g., Levenshtein distance, or the like, between the texts to determine how similar they are to one another. If this distance is above or below a given threshold, depending on the implementation, then the two texts are considered to be similar to one another.

In addition to the topology data structure and knowledge articles/knowledge data structures, the illustrative embodiments further operate on one or more automation catalog data structures specifying the automation tools and their characteristics available to site reliability engineers (SREs) or other personnel that manage and maintain the IT infrastructure. The automation catalog data structure may specify the automation tools, what tasks for IT incident remediation they perform, what skills are associated with those automation tools, and the like. That is, the automation catalog data may have metadata such as the automation tool name and a description of the automation tool. The automation tool description explains the purpose of the automation tool in natural language, e.g., “roll back mongo replica set”, from which the mechanisms of the illustrative embodiments are able to identify the type of skills that this automation tool provides, e.g., action, rollback, fallback, monitoring, or the like. A sentence similarity measure may again be used to match between the IT incident remediation action, as determined from the knowledge data structures, and the automation tool descriptions. Once relevant automation tool descriptions are found, e.g., matching descriptions having a similarity measure equal to or above a predetermined threshold, the automation tool is mapped to the corresponding skill(s) and remediation tasks with which it has a sufficiently high matching description as indicated by the similarity measure and the established threshold.

An additional input may be provided that describes SREs and/or SRE teams. The SRE data may specify the skills associated with different SREs and/or SRE teams, e.g., action skills, monitoring skills, rollback skills, and fallback skills. These indicate expertise of the SREs and/or SRE teams with regard to handling IT incident remediation tasks requiring these various skills. This data may be acquired by tracking IT incident tasks to which the SREs and/or SRE teams are assigned and which have user feedback or other metrics that specify the successfulness of the performance of those IT incident tasks and the corresponding skills associated with those IT tasks. Over time, such user feedback and metrics may be acquired and analyzed to identify the skills that the individual SREs and/or SRE teams have, and possibly which they do not have, e.g., skills such as mongo, server provision, security patch, etc. For example, if an SRE, over time, consistently performs IT incident tasks that require action skill A, and those IT incident tasks are performed successfully, then the SRE may be associated with action skill A in an entry for that SRE in an SRE database. In addition, or alternatively, the entries for the SREs may be manually populated to specify what skills each SRE/SRE team may have, such as specifying certifications, education types, and the like, which may be pertinent to IT incident task performance. Other methodologies and mechanisms may be used to acquire or otherwise populate entries in the SRE database for the various SREs and/or SRE teams.

As with the other inputs, a sentence similarity measure may be used to match between automation tool descriptions and SRE skills. Once the relevant SRE/SRE team is identified, e.g., having a similarity measure equal to or greater than a predetermined threshold, the SRE is mapped as the fallback for that automation tool.

Based on these inputs, the exploratory orchestration computing tool of the illustrative embodiments performs exploratory orchestration of IT incident remediation workflows. To support such exploratory orchestration, the exploratory orchestration computing tool may extract, using specifically configured NLP algorithms, correlations between IT incident remediation tasks and required skills for performing these remediation tasks. For example, the descriptions of IT incidents and the remediation tasks used to address these IT incidents may be extracted from the natural language content of the knowledge articles, e.g., SRE/SRE team reports/logs, user feedback documents, social networking posts, and the various other natural language content documents discussed above, and the like. Moreover, indications of skills required to perform the IT remediation tasks may also be extracted from the natural language content. For example, for an IT incident, once a remediation action is identified from the natural language content of the knowledge data structures by performing a matching of the IT incident, source of the IT incident, etc., to textual descriptions of IT incidents and their corresponding remediation actions, such as by way of a sentence similarity matching, a similar sentence similarity measure matching may be used between the remediation action description and the automation tool descriptions.

Based on user input specifying skills, relationships between skills, and skill associations with IT remediation tasks, and/or data extracted from the natural language content of documents, such as identifying skills based on a vocabulary of skill terms/phrases, skills and relationships between skills may also be identified. For example, for a given skill, the description of that skill in a skill catalog or knowledge article, or other portion of natural language content, may specify that the skill is a particular type of skill used with other skills. For example, for a first skill the description may be “Uninstall” indicating that it is a rollback type of skill for an “Install” skill, e.g., “Uninstall Java” is the rollback skill for the skill “Install Java”.

In other illustrative embodiments, as with all of the sentence similarity measure based evaluations, a machine learning computer model may be trained through a machine learning process to take a description and determine skills described in that description and their relationships with other skills, as well as their classification. For example, a machine learning model may be trained to take as an example input the text “uninstall Java” and may output a classification of “rollback”, or “install Java” and output a classification of “action”. In some illustrative embodiments, the machine learning computer model may be trained to compute the similarity of two descriptions based on named entities, e.g., input: [“Install Java”, “Uninstall Java”] and the output may be “Named Entity Match=100%. Together this information is combined to indicate that “Uninstall Java” is a rollback skill for “Install Java” because of the high (above a threshold) named entity matching. The skills information and relationships between skills may be stored in a skills relationship graph data structure for use in orchestrating IT incident remediation tasks in accordance with one or more of the illustrative embodiments.

Thus, skills and classifications of these skills as one of the predetermined types, e.g., action, monitor, rollback, or fallback, may be performed based on the information extracted from the NLP documents, knowledge articles, skill catalog and the like, such as the particular context of the skill terms/phrases in the descriptions of the NLP documents, knowledge articles, etc. The context may include terms/phrases, or patterns of natural language content, indicative of whether the corresponding skill terms/phrases are referencing the performance of a particular action, performance of a monitoring action, rolling back a modification performed, or performing an alternative action, such as a fallback action. For example, natural language text may specify that a particular IT remediation task was performed for an IT incident, and that the skill required was a storage system reconfiguration skill, and that this task was preformed as part of an alternative to another action, and thus, is a fallback IT remediation task.

In some illustrative embodiments, a skills catalog data structure may be specified that comprises a set of predefined skills and various attributes of those skills. This skill attribute information may include a description of the skill, inputs required for performance of the skill, and the skill type or classification, e.g., action, monitoring, rollback, or fallback. For example, the skill to install Java may have attribute information such as {description: install Java; input required: [Operating system, Java version]; skill type: action} .

The correlation between IT incidents and remediation tasks may be used to generate a knowledge graph data structure in which nodes may represent IT incidents and IT remediation tasks, and these nodes may be linked by edges representing relationships between the IT incidents and IT remediation tasks. The nodes corresponding to IT remediation tasks may have characteristics which specify the particular skills required to perform the IT remediation tasks and their corresponding skill types, as extracted from the knowledge data structures. These skills may be determined from the sentence similarity matching and then skill term extraction through natural language processing, along with correlation of those skill terms with the skills catalog data or the like. Thus, a knowledge graph, which may be a directed acyclic graph (DAC) or other graph data structure comprised of nodes and edges, or other data structure specifying the correlation between IT incidents, IT remediation tasks, and skills associated with these IT remediation tasks, may be generated and used with the illustrative embodiments. This knowledge represented in a data structure is referred to herein as a knowledge data structure and may have various formats depending on the desired implementation.

The knowledge data structure may be correlated with an IT topology data structure that specifies the connections between IT resources, e.g., software, hardware, and/or combinations of software and hardware, in an IT infrastructure. That is, the IT remediation tasks may be correlated with the IT resources that are associated with or needed to perform the IT remediation tasks based on the knowledge articles for each IT resource as mentioned previously. That is, the knowledge articles indicate IT incidents associated with their corresponding IT resource and the remediation actions taken with regard to those IT incidents. Thus, it is possible to correlate the IT resource with IT incidents and corresponding remediation actions from the knowledge articles. Based on the correlations between IT remediation tasks and the IT resources, and their dependencies, e.g., what IT resources are dependent on others as specified in the IT topology data structure input, an IT remediation task sequencer may determine an ordering of IT remediation tasks may be generated.

For example, when an IT incident occurs, the IT incident often affects more than one IT resource in the IT infrastructure and thus, various IT resources will trigger alerts that are sent to monitoring systems of the IT infrastructure. In some illustrative embodiments, the IT remediation task sequencer looks at the stream of IT alerts that are received from the monitoring systems and correlates these IT alerts with IT resources from which the alerts are received. The IT topology is consulted to order the IT alerts from an upstream to downstream ordering based on the dependencies between IT resources specified in the IT topology. Then, for each IT alert, the corresponding knowledge article is retrieved and the sequence of remediation tasks is extracted from the knowledge article via a natural language processing of the knowledge article. For example, assume that the knowledge article includes the statement “For error code 1223432 the following steps have to be performed: 1) Reinstall Java; 2) Restart Server”, then the remediation tasks would be [“Reinstall Java”, and “Restart Server”] (it should be appreciated that this is a simple example, and the sequence of remediation tasks may, in some cases, have many more tasks and more complex ordering of tasks than in this simple example). It should be appreciated that in some cases, this sequence of remediation tasks may be extracted using NLP a priori and stored as a data structure associating the IT incident with a set of remediation tasks based on the knowledge article, which may then be updated periodically in case the knowledge article has been updated, e.g., each time an update to the knowledge article is performed, the NLP extraction of a sequence of remediation tasks may be performed.

Based on the IT remediation tasks, and the ordering of IT remediation tasks for addressing an IT incident, an IT remediation task selection engine may select tools and/or SREs/SRE teams to perform required IT remediation tasks. That is, the IT remediation task selection engine may correlate the IT remediation tasks with skills required to perform the IT remediation tasks. This again may involve a sentence similarity matching between the descriptions and attributes/characteristics of the IT remediation tasks and the automation tools and SREs/SRE teams with the skill descriptions and attributes/characteristics to find the highest matching correlations. Based on the skills required, corresponding automation tools providing the required skills may be identified by performing a lookup of the required skills with skills specified in entries of the automation catalog data structure and/or performing a sentence similarity matching with descriptions of the automation tools in the automation catalog data structure. That is, required skills are correlated with automation tools that provide those required skills, as specified in the automation catalog that is provided as input. For those skills where there is no correlated automation tool available to perform an IT remediation task requiring that skill, a skill gap may be identified.

In some illustrative embodiments, for IT remediation tasks in the sequence of IT remediation tasks for handling the IT incident, fallback tasks, corresponding skills, automated tools providing the skills for the fallback tasks, and/or SREs/SRE teams that provide the skills of the fallback tasks may be identified from the IT topology, knowledge data structures, automation tool catalog, and SRE data inputs. These fallback tasks may be used to generate alternative sequences for handling the IT incident to thereby perform “exploratory” orchestration of IT incident remediation.

These alternative sequences may be used in the event that a primary sequence for handling the IT incident fails at particular points during execution of the sequence of IT remediation tasks. In some illustrative embodiments, these alternative sequences may be generated prior to execution of the primary sequence, or may be generated dynamically in response to an indication that an IT remediation task failed when executing the primary sequence.

For skill gaps identified by the IT remediation task selection engine, a first determination may be made as to whether the IT remediation task has associated fallback IT remediation tasks that could be performed instead of the primary IT remediation task. If there is a fallback IT remediation task associated with the primary IT remediation task, a further determination may be made as to whether or not an automation tool is available that provides the skills needed to perform the fallback task. That is, again, the skills of the fallback task may be used to perform a lookup operation in the automation tool catalog to determine if there is an available existing automation tool that provides those skills. If so, then the fallback task may be utilized in the resulting sequence of IT remediation tasks for handling the IT incident. Again, this is a type of “exploratory” orchestration of IT incident remediation by finding the optimum combination of IT remediation tasks to perform the sequence of IT remediation tasks to handle an IT incident.

If a fallback IT remediation task having skills that are satisfied by an automated tool is not available, the associated skills are used as a basis for performing a lookup in the SRE input data for an SRE/SRE team that provides the skill(s) of the skill gap. The entries in the SRE input data may include contact information for the SRE/SRE teams for correlating their performance of assigned IT incident remediation tasks in accordance with the ordering, or sequence, of IT incident remediation tasks. Thus, the sequence of IT incident remediation tasks may comprise IT incident remediation tasks that are performed by automated tools, IT incident remediation tasks that are performed by manual or semi-manual efforts of SREs and/or SRE teams, or any suitable combination or mix of automated tool and SRE performed IT incident remediation tasks. Thus, in some illustrative embodiments, a mixed methodology sequence of IT incident remediation tasks may be generated and managed by the automated mechanisms of the illustrative embodiments.

The IT remediation task selection engine and IT remediation task sequencer may make use of one or more machine learning trained computer tools to facilitate decision making for sequencing IT remediation tasks based on the various inputs discussed above. These decisions may include IT remediation task selection which may be based on an evaluation of probabilities that a particular IT remediation task will be successfully performed with various automation tools. This evaluation may take into account various input features including the particular automation tools available to perform the task, whether the task can be easily rolled-back, whether the is a fallback IT remediation task available for the primary IT remediation task, and the like. In addition, these decisions may evaluate each alternative or fallback IT remediation task for primary IT remediation tasks and generate probabilities of successful completion based on the various features. This allows for selection of IT remediation tasks that are not necessarily the highest probability, but which have additional features indicative of a more optimal solution, or less risky solution.

Each alternative for performing operations to address an IT incident may be evaluated by the machine learning trained computer tools to identify patterns of input features and corresponding probabilities/confidence scores, for those alternatives successfully performing the corresponding operations, i.e., a degree of matching of the IT remediation task descriptions to the IT incident descriptions which is indicative of the IT remediation task being appropriate for addressing the IT incident. For example, the machine learning trained computer tools may, in some illustrative embodiments, generate scores for IT remediation tasks and corresponding skills required by the IT remediation tasks, and may evaluate these IT remediation tasks and skills with regard to minimum threshold scores, whether the skills have fallback skills, whether the skills have corresponding rollback skills, and the like, and may determine alternative skills, and if need be, alternative IT remediation tasks having alternative skills, for generating a sequence of IT remediation tasks to handle the IT incident. It should be appreciated that a “skill” and a “task” are two separate concepts, where a task is one of the steps in the IT remediation sequence, while a skill is a capability of an automation in an automation library, or a capability of a site reliability engineer (SRE) or other authorized human being, depending on the context. As will be described herein, for a given task, an orchestrator matches the task to one or more skills, such as by using a natural language processing classifier/intent classifier, which is a machine learning trained computer model, and provides a score indication indicating the strength of the match. In some cases, the skills with the best match score are selected, whereas in other cases, skills that may not have the best match score may be selected based on an evaluation of other criteria, such as discussed hereafter.

For example, a primary sequence may be generated that comprises one or more IT remediation tasks having the following combination of skills: Skill A->Skill B (score=0.98)->Skill C. Assume that Skill B does not have a rollback skill associated with it, but that there is a fallback skill, Skill D, for Skill B that, while having a lower score for performing the related IT remediation task, e.g., 0.95, but which is still higher than a minimum threshold score, has a rollback skill associated with it. In such a situation, the alternative of Skill D may be a better fit to performing the related IT remediation task, or an alternative IT remediation task, as it provides sufficient confidence/probability that the IT remediation task will be successfully performed, while also providing a rollback capability that Skill B does not have. The machine learning trained computer tools may assess the alternatives and select the alternative sequence, i.e., Skill A->Skill D (score=0.95)->Skill C, as the skills for performing an IT remediation task and may be used to recommend particular automation tools and/or SRE/SRE teams for performing the IT incident remediation task sequence.

An orchestration engine of the illustrative embodiments then orchestrates the execution of the resulting sequence of IT remediation tasks for handling the IT incident. For example, the orchestration engine may invoke the automated tools for performing IT remediation tasks for which there are automated tools, monitor the automated tools performance for messages specifying that the automated tool completed the IT remediation task successfully or not, and then either take alternative action if unsuccessful, or initiate the next task in the sequence providing the results of the previously executed task. In the case of tasks that are to be completed by SREs/SRE teams, automated communications may be generated and transmitted to the SREs/SRE teams as specified in the SRE data, so as to initiate SRE performance of the task. Moreover, the orchestration engine may monitor for responsive communications from the SREs/SRE teams indicating that they have completed the assigned IT remediation task successfully or not. If successfully completed, the orchestration engine may then initiate the next task in the sequence, if there is one, and provide the results of the previously performed task(s).

If one or more tasks of the sequence are not able to be successfully performed, as noted above, the mechanisms of the illustrative embodiments may look for fallback or rollback tasks to perform to either rollback changes made by previous tasks, or generate alternative sequences based on fallback skills and corresponding IT remediation tasks. In the case where there is no rollback and/or fallback skill and IT remediation task, then SREs/SRE teams may be automatically notified of this inability to perform the IT remediation task and request manual intervention. In the case where the sequence of the IT remediation tasks cannot be completed successfully, then an authorized user may be automatically notified of the IT incident and the IT remediation tasks that are not able to be performed successfully to remediate the IT incident.

Thus, the illustrative embodiments provide an automated improved computing tool for performing exploratory orchestration of IT incident remediation workflows, or sequences of IT remediation tasks, which may be composed of mixed methodologies of IT remediation task performance. The illustrative embodiments provide automated improved computing tools to orchestrate, monitor, and manage the performance of these IT incident remediation workflows. Thus, the illustrative embodiments are able to leverage the skills and capabilities of both automated tools and SREs/SRE teams to facilitate an optimum solution to remediating IT incidents, resulting in more efficient workflows and more efficient solutions to IT incidents. This in turn improves IT infrastructure operation and availability of IT resources.

It should be appreciated that these automated operations of the exploratory orchestration computing tool of the illustrative embodiments are specifically to be performed in an automated manner and are specifically directed to improving the way in which IT incidents are resolved using automated computing tools and/or SREs/SRE teams. All of the functions of the illustrative embodiments as described herein are intended to be performed using automated processes without human intervention. While human beings may benefit from the operation of the illustrative embodiments, the illustrative embodiments of the present invention are not directed to actions performed by the human being, but rather computer logic and functions performed specifically by the improved computing tool. Moreover, while human beings, e.g., SREs/SRE teams, may be involved in performing IT remediation tasks, the illustrative embodiments are not directed to the manual efforts performed by the SREs/SRE teams, but instead to the mechanisms of the automated computing tool that performs the operations for generating sequences, or workflows, of IT remediation tasks based on AI/machine learning based evaluation of IT incidents, IT remediation tasks, automated tools, and SREs/SRE teams, as well their corresponding skills, and then also automatically initiating and orchestrating the performance of these IT remediation tasks so as to address IT incidents.

That is, while the remediation operations that are recommended or initiated by the mechanisms of the illustrative embodiments may involve some human intervention to perform some required tasks of the remediation operations, the invention itself is directed to the improved computing tool and computing tool operations that determine the particular tasks of the remediation operation and provide recommendations and in some cases initiate the performance of the remediation operation, including communications with elements required to perform the remediation operation. Thus, the illustrative embodiments are not organizing any human activity, are not simply implementing a mental process in a generic computing system, or the like, but are in fact directed to the improved and automated computer logic and improved computer functionality of an improved computing tool, even though human beings may make use of the results generated by the mechanisms of the illustrative embodiments.

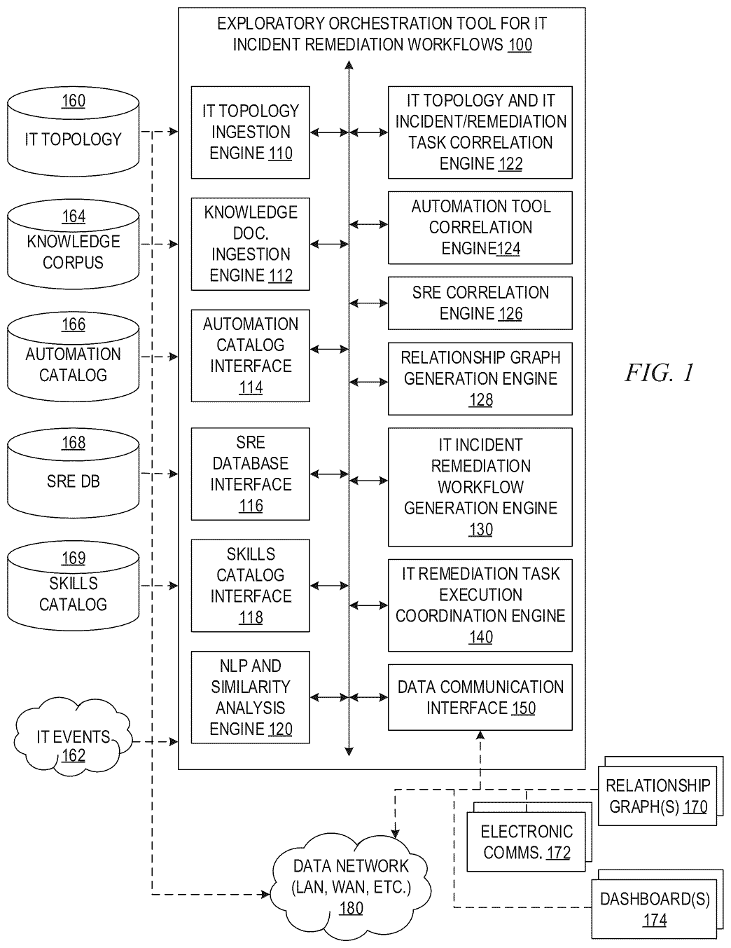

FIG. 1 is an example block diagram illustrating the primary operational components of an exploratory orchestration computing tool for information technology (IT) incident remediation workflows in accordance with one illustrative embodiment. The elements shown in FIG. 1, while shown as blocks, are in fact computing components that are part of an exploratory orchestration tool for IT incident remediation workflows. These components may include logical and/or computer hardware that perform and facilitate the operations attributed to these components in the present description. Moreover, while the primary operational components will be described herein, it should be appreciated that the actual implementations may include additional components that facilitate the operations of the primary operational components, such as operating systems, libraries, communication interfaces, storage elements, networking elements, application programming interfaces, various data structures, and the like. In addition, while various components are shown separately in FIG. 1, it should be appreciated that the various components, or subsets of the components, may be combined without departing from the spirit and scope of the present invention.

As shown in FIG. 1, the exploratory orchestration tool for IT incident remediation workflows 100, hereafter referred to as the exploratory orchestration tool 100 for short, comprises an IT topology ingestion engine 110, knowledge documentation ingestion engine 112, an automation catalog interface 114, a SRE database interface 116, a skills catalog interface 118, natural language processing (NLP) and similarity analysis engine 120, an IT topology and IT incident/remediation task correlation engine 122, and automation tool correlation engine 124, a SRE correlation engine 126, an relationship graph generation engine 128, an IT incident remediation workflow generation engine 130, and an IT remediation task execution coordination engine 140. These elements may operate in conjunction with various input data structures and may generate data structures, electronic or data communications, and the like. These input/output data structures may be obtained from and/or transmitted to, various other computing devices via a data communication interface 150 which may provide a data communication pathway coupled to one or more wired/wireless data networks. For example, the input data structures that may be received from one or more computing devices (not shown) via one or more data networks (not shown) may include an IT topology data structure 160, a stream of IT events or incidents 162, a knowledge corpus 164, an automation catalog database 166, an SRE database 168, and a skills catalog database 169. It should be appreciated that while these input data 160-169 are shown as individual data structures or databases, they may each be composed of multiple data structures, databases, or the like, which may be associated with different computing systems/devices that serve as sources of this data. It should also be appreciated that while these input data 160-169 are shown as outside the exploratory orchestration tool 100, these data structures and databases may be stored in storage and/or memory of the exploratory orchestration tool 100 or otherwise accessible by the exploratory orchestration tool 100. Examples of outputs that may be generated by the illustrative embodiments include one or more relationship graph data structures 170, electronic communications to computing devices 172, dashboard outputs 174, and the like.

The various ingestion engines and interfaces 110-118 provide data communication interfaces and logic that facilitates the accessing of various input data and generation of in-memory representations of this input data for use by the other mechanisms of exploratory orchestration tool 100. The NLP and similarity analysis engine 120 provides specifically configured natural language processing (NLP) logic that parses input natural language content, identifies terms/phrases or patterns of content for which the NLP logic is configured, and evaluates the context of these terms/phrases or patterns of content to extract information of relevance to the operation of the engines which are utilize the NLP logic and similarity analysis engine 120. For example, the NLP logic may be configured with a vocabulary of terms/phrases specific to IT incidents, IT remediation tasks and actions, contextual terms/phrases that provide features indicative of skills required by IT remediation tasks, types or classifications of IT remediation tasks, and the like. The similarity analysis logic of the NLP and similarity analysis engine 120 may determine similarities between portions of text for correlation purposes. The various engines 122-140 may invoke the NLP and similarity analysis engine 120 to perform various types of NLP and similarity analysis operations to facilitate and support the operations performed by these engines 122-140.

The IT topology and IT incident/remediation task correlation engine 122 provides logic, which may include one or more artificial intelligence/machine learning computer models, that operates to correlate IT incidents with IT topology and IT remediation tasks to address the IT incidents, as well as identifies the required skills associated with the IT remediation tasks. The automation tool correlation engine 124 correlates the required skills for the IT remediation tasks with skills associated with automation tools. The SRE correlation engine 126 provides logic that correlates required skills for IT remediation tasks with skills associated with SREs and/or SRE teams.

It should be appreciated that the various correlations may make use of the NLP and similarity analysis, such as sentence similarity between IT remediation task descriptions, automation tool descriptions, and SRE data, to indicate which of these are related to one another to a sufficient degree, e.g., having a similarity measure equal to or greater than a predetermined threshold. Moreover, in performing the similarity analysis, the NLP mechanisms may operate to extract key terms/phrases corresponding to the vocabulary with which the NLP logic is configured, and transform the natural language content to a vector representation based on the extracted key terms/phrases. For example, the vocabulary may include, among other terms/phrases, skill terms/phrases indicating particular skills that are required to performing the IT remediation task, skills that a particular automation tool provides, and skills that a particular SRE/SRE team provides. The similarity analysis may then perform a vector similarity analysis to generate a distance measure and this distance measure can be used along with a predetermined threshold to determine which portions of text are sufficiently correlated to indicate a match. This is just one example for identifying correlated IT remediation tasks, automation tools, and SRE data, and others, as will become readily apparent to those of ordinary skill in the art in view of the present description, may be used without departing from the spirit and scope of the present invention.

The relationship graph data structure generation engine 128 generates one or more relationship graph data structures 170 that provide data representations of the relationships and dependencies between skills provided by the automation tools and

SREs/SRE teams, e.g., which automation tools and SREs/SRE teams provide action, monitoring, fallback and/or rollback skills for other skills. There may be separate relationship graph data structures 170 for different skills, in some instances. The relationship graph data structures 170 may be used by artificial intelligence/machine learning (AI/ML) logic/computer models of one or more of the engines 122-140 when making determinations as to which automation tools and/or SREs/SRE teams to use to perform IT remediation tasks of an IT remediation task workflow. For example, after determining, based on the IT incident, the IT remediation task workflow and the skills for each IT remediation task, the automation tool correlation engine 124 and SRE correlation engine 126 may identify particular automation tools and SREs/SRE teams to assign to each of the IT remediation tasks in the workflow (sequence).

The IT incident remediation workflow generation engine 130 generates the IT incident remediation workflow that is to be executed to address the IT incident. This IT incident remediation workflow comprises the sequence of IT remediation tasks and the corresponding automation tools and/or SREs/SRE teams that perform the IT incident remediation tasks. The generation of the IT incident remediation workflow may include identifying skill gaps in the sequence and coordinating a sequence of automated tools and SRE/SRE team execution of IT incident remediation tasks, such as when there are skill gaps not satisfied by automation tools, such that the IT incident remediation workflow may be a mixed methodology workflow.

The IT incident remediation workflow generation engine 130 generates the workflow and provides it to the IT remediation task execution coordination engine 140 which operates to initiate automated tool execution of IT remediation tasks in accordance with the sequence of the IT remediation tasks, waiting for IT remediation tasks to be completed successfully before progressing to dependent IT remediation tasks. In addition, for IT remediation tasks which are to be handled by SREs/SRE teams, the IT remediation task execution coordination engine 140 may automatically generate and transmit electronic communications 172 to the appropriate communication channels associated with those SREs/SRE teams to facilitate their performance of the corresponding IT remediation tasks. The IT remediation task execution coordination engine 140 further provides logic for monitoring for the successful, or unsuccessful, completion of the IT remediation tasks and performing responsive actions based on whether such tasks were completed successfully or not. For example, in the case of successful completion, the engine 140 may progress to the next IT remediation task in the sequence set forth in the workflow and initiate execution/transmit communications to facilitate performance of the IT remediation task. This may involve transmitting data representing results of the previous IT remediation task(s) in the workflow that were successfully performed. In the case of an unsuccessful completion of the IT remediation task, the engine 140 may invoke logic of the IT incident remediation workflow generation engine 130 to identify alternative, fallback, or even rollback IT remediation tasks and corresponding skills to handle the unsuccessful completion of the IT remediation task, and may notify appropriate personnel if necessary via the electronic communications 172.

The exploratory orchestration tool 100 may provide outputs during the process of handling an IT incident from receipt of the IT incident to generation of the IT incident remediation workflow, to execution of the IT incident remediation workflow. These outputs may comprise one or more dashboards 174 that show authorized personnel the status of the remediation of the IT incident, what IT remediation tasks are being performed, what automation tools are performing those IT remediation tasks, what SREs/SRE teams are performing the IT remediation tasks, the status of the completion of these tasks, what skills are involved in the performance of the IT remediation tasks, and the like.

As shown in FIG. 1, access to the various input data structures/databases 160-169 and IT events, e.g., alerts, from IT infrastructure monitoring systems, may be obtained through the data communication interface 150 and one or more data networks 180. Thus, the inputs 160-169 may be provided on various computing devices, computing systems, and the like, that are coupled to the data network 180. Similarly, outputs generated by the exploratory orchestration tool 100 may be likewise provided to other computing devices/systems via the data network 180, e.g., electronic communications 172, dashboards 174, and outputs of relationship graphs 170.

Having explained the various components of the exploratory orchestration tool 100, the following will provide an example of an operation of the exploratory orchestration tool 100 in response to the receipt of an IT incident from one or more monitored computing systems (not shown) of an IT infrastructure (not shown). The IT incident may comprise one or more alerts generated by, for example, monitoring software, agents, and the like, that monitor the various IT resources of the IT infrastructure for anomalous operations, failures, and the like. When such anomalous operations, failures, and the like, are detected, a corresponding alert is generated and transmitted/logged for remediation. A single IT incident may affect multiple IT resources and thus, may have multiple different alerts associated with the IT incident.

The IT incident, comprising one or more alerts, or IT events, are received as a stream of input data 162 via the data network 180 and communication interface 150. In response to an IT incident being received, the IT topology and IT incident remediation task correlation engine 122 identifies the affected IT resources in the IT infrastructure from the IT topology data 160 and the knowledge corpus 164. For example, the IT events/alerts specify the source of the IT event/alert, such as in metadata of the IT event/alert, as well as what abnormal condition or failure caused the IT event/alert to be generated. This information may be parsed and extracted, such as by the IT topology and IT incident remediation task correlation engine 122 invoking the NLP and similarity analysis engine 120, and may be correlated with IT topology information from the IT topology data 160 to identify the IT resources associated with the IT incident. For example, even though an IT event/alert may specify a particular IT resource, there may be related IT resources that are also affected by this IT event/alert that are not specifically identified in the IT event/alert itself, e.g., dependent or downstream IT resources. These additional IT resources may be identified by correlating the IT events/alerts with the corresponding IT resources in the topology data 160 and identifying, from the hierarchy of the topology data 160, other IT resources that may be affected.

The identification of the affected IT resources is used by the IT topology and IT incident remediation task correlation engine 122 to retrieve knowledge data structures from the knowledge corpus 164. In some illustrative embodiments, the knowledge corpus 164 comprises knowledge articles associated with different IT resources, or IT resource types. The knowledge articles may be generated from NLP parsing and processing of natural language documents from various sources including site reliability engineer (SRE) logs/reports, social networking sources, trade publications, or any other source of natural language content that may be targeted to IT incident remediation. The knowledge articles correlate IT incidents, IT events/alerts, and remediation tasks for addressing these IT incidents and/or IT events/alerts. That is, in some illustrative embodiments, the knowledge articles may have sections that specify IT application related issues and corresponding remediation actions. Thus, by retrieving the knowledge articles for the affected IT resources, the IT topology and IT incident remediation task correlation engine 122 is able to find, documented therein, remediation tasks for addressing IT incidents and IT events/alerts associated with that IT resource.

For each knowledge article retrieved, the IT topology and IT incident remediation task correlation engine 122 searches the knowledge article for a mention of the IT incident and/or IT event/alert, and corresponding remediation tasks. This searching may involve invoking NLP and similarity analysis engine 120 to parse the knowledge article and look for similarities between the IT incident and/or IT event/alert content and the content of the knowledge article. As noted above, this may involve performing a sentence similarity analysis using vectorized representations of natural language content and a distance or similarity scoring based evaluation using one or more predetermined thresholds for determining sufficient similarity for identifying matches. In some cases, the knowledge articles may include metadata which may have tags and values that specify metadata content indicative of IT incidents, remediation actions, and the like, which may also be parsed and processed to extract features of such IT incidents and remediation actions. In the case of a similarity analysis, the IT topology and IT incident remediation task correlation engine 122 identifies instances from the knowledge article that have at least a predetermined threshold level of similarity to the IT incident and/or IT event/alert description or natural language content, and these portions may be ranked based on the level of similarity. The highest ranking portions that specify IT remediation tasks, may then be selected for use in generating a sequence of one or more IT remediation tasks to perform to address the IT incident.

Thus, the IT topology and IT incident remediation task correlation engine 122 identifies a sequence of one or more IT remediation tasks to address the IT incident, which serves as a basis for generating an IT remediation task workflow. The IT remediation tasks may further be sequenced according to the hierarchy of the IT topology 160, i.e., an ordering based on which IT resources are affected by other IT resources. The identified IT remediation tasks are then associated with skills required to perform the IT remediation tasks. In some illustrative embodiments, a mapping data structure may be provided that maps known IT remediation tasks to corresponding skills, and those skills to particular skill types, e.g., action, monitor, rollback, or fallback skills. In other illustrative embodiments, a skills catalog database 169 may be provide that has entries for each of a plurality of predefined skills, where each entry further provides a natural language description of the skill. Similar to the above, NLP and similarity analysis by the engine 120 may be performed to determine sentence similarity between the description of skills in the skills catalog database 169 and the description of the IT remediation tasks extracted from the knowledge articles for the various IT resources corresponding to the IT incident, as identified through the above process. In some illustrative embodiments, once a correlation is made between an IT remediation task and a skill through such a similarity analysis, this correlation may be stored in a mapping data structure such that a lookup operation may be used on the mapping data structure rather than having to perform similarity analysis each time this IT remediation task is identified for addressing an IT incident. Thus, if a mapping of an IT remediation task to skills is not present in the mapping data structure through a lookup operation, then the similarity analysis may be employed to identify skill(s) and then generate a new entry in the mapping data structure.

A similar mapping of skills to automation tools and to SREs/SRE teams may be employed for storing skill information for automation tools and SREs/SRE teams in the ingested automation catalog 166 and SRE database 168. That is, in some cases a mapping of automation tools to skills and SREs/SRE teams to skills may be provided through user input and/or determined through a similarity analysis so that automation tools are matched to skills provided by those automation tools and SREs/SRE teams are matched to skills provide by those SREs/SRE teams. In some illustrative embodiments the similarity analysis may be performed based on descriptions of predefined skills and descriptions of the automation tools and SREs/SRE teams. For automation tools, application specifications provided in the automation catalog 166, and the like, may provide a textual description of the automation tool against which a sentence similarity evaluation is performed with regard to the skill descriptions in the skill catalog 169 to identify skills having at least a predetermined level of similarity of description to that of the automation tool. For the SREs/SRE teams, the SRE data 168 may comprise background information, information about certifications held by the SRE/SRE team, previous IT incidents successfully addressed by the SRE/SRE team, and the like. This information may be provided in a natural language format and may be matched to skills in the skill catalog 169 using a sentence similarity analysis similar to that described above.

It should be appreciated that the similarity analysis described above may be performed using one or more machine learning trained computer models trained to perform the particular similarity analysis between the input features of the specified natural language content being compared. Thus, a first machine learning computer model may be trained to perform similarity analysis between IT remediation task descriptions and skill descriptions, a second machine learning computer model may be trained to perform similarity analysis between automation tool descriptions and skill descriptions, a third machine learning computer model may be trained to perform similarity analysis between SRE/SRE team descriptions and skill descriptions, etc. These machine learning computer models may be implemented in the various engines 122-126. Once skills are associated with automation tools and/or SRE/SRE teams, their entries in the automation catalog 166 and SRE database 168 may be updated to specify the mapping with predefined skills.

Based on the associations of skills with the IT remediation tasks, the automation tools, and the SRE/SRE teams, a correlating of IT remediation tasks with automation tools and SRE/SRE teams may be made possible. These correlations identify candidates for implementing the IT remediation tasks, where these candidates may comprise automation tools, SRE/SRE teams, or a combination of both, or in some cases neither if there are no automation tools or SRE/SRE teams that provide the requisite skills to perform the IT remediation task. Thus, for each IT remediation task identified from the knowledge articles for handling the IT incident, the skills required for that IT remediation task are identified, and then those skills are matched to the skills that are provided by automation tools as specified in the automation tool catalog data 166.

In matching the IT remediation tasks to automation tools based on a matching of skills, a relationship graph 170 may be generated by the relationship graph generation engine 128 for identifying the hierarchy and dependency of skills, such as action skills, their related monitoring skills, their related rollback skills, and their related fallback skills. This hierarchy and dependency of skills may be utilized when selecting automation tools and SREs/SRE teams for performance of IT remediation tasks. For example, in addition to matching the skills, other characteristics, such as whether a candidate automation tool provides a skill that has a rollback skill or not, may be used to select between automation tools and/or SREs/SRE teams.

The relationship graph data structures 170 are used with the candidate automation tools and candidate SRE/SRE teams identified through the operation of engines 122-126, to formulate one or more IT incident remediation workflows by the IT incident remediation workflow generation engine 130. A primary IT incident remediation workflow may be generated that orders IT incident remediation tasks in accordance with the IT topology 160, and each IT incident remediation task has associated candidate automated tools and/or SREs/SRE teams based on a skill matching as previously described above. The IT incident remediation workflow generation engine 130 may comprise one or more machine learning trained computer models that evaluate each of the candidates for each of the IT incident remediation tasks to identify an automated tool and/or SRE/SRE team to assign to performance of the IT incident remediation task. This evaluation may take into consideration various characteristics/features of the candidates, such as whether the candidates have fallback or rollback skills associated with them.

As part of the IT incident remediation workflow generation, skill gaps may be identified. A skill gap is one where there is no automated tool that provides the requisite skill to perform the IT remediation task, as previously noted above. For those skill gaps, alternative candidates are evaluated, e.g., fallback skills and automated tools that provide those fallback skills. If no fallback skills and/or automated tools that provide those fallback skills are identified for an IT remediation task, then an SRE/SRE team that provides the primary skill and/or the fallback skill may be selected for assigning to the IT remediation task. The identification of fallback skills, rollback skills, monitoring skills, and the like, may be made possible by looking a the relationship graph data structures 170 generated by the relationship graph generation engine 128 which identify the relationships between skills in the skill catalog 169.

Thus, for skill gaps, the IT incident remediation workflow generation engine 130 makes a first determination as to whether the IT remediation task has associated fallback IT remediation tasks that could be performed instead of the primary IT remediation task. If there is a fallback IT remediation task associated with the primary IT remediation task, a further determination may be made as to whether or not an automation tool is available that provides the skills needed to perform the fallback task. That is, again, the skills of the fallback task may be used to perform a lookup operation or matching in the automation tool catalog 166 to determine if there is an available existing automation tool that provides those skills. If so, then the fallback task may be utilized in the resulting sequence of IT remediation tasks for handling the IT incident. If a fallback IT remediation task having skills that are satisfied by an automated tool is not available, the associated skills are used as a basis for performing a lookup or matching in the SRE database 168 for an SRE/SRE team that provides the skill(s) of the skill gap.

The entries in the SRE database 166 may include contact information for the SRE/SRE teams for correlating their performance of assigned IT incident remediation tasks in accordance with the ordering, or sequence, of IT incident remediation tasks. Thus, the sequence of IT incident remediation tasks may comprise IT incident remediation tasks that are performed by automated tools, IT incident remediation tasks that are performed by manual or semi-manual efforts of SREs and/or SRE teams, or any suitable combination or mix of automated tool and SRE performed IT incident remediation tasks. Thus, in some illustrative embodiments, a mixed methodology sequence of IT incident remediation tasks may be generated and managed by the automated mechanisms of the illustrative embodiments.

The IT incident remediation workflow generation engine 130 may make use of one or more machine learning trained computer models to facilitate decision making for sequencing IT remediation tasks based on the various inputs discussed above. These decisions may include IT remediation task selection which may be based on an evaluation of probabilities that a particular IT remediation task will be successfully performed with various automation tools. This evaluation may take into account various input features including the particular automation tools available to perform the task, whether the task can be easily rolled-back, whether the is a fallback IT remediation task available for the primary IT remediation task, and the like. In addition, these decisions may evaluate each alternative or fallback IT remediation task for primary IT remediation tasks and generate probabilities of successful completion based on the various features. This allows for selection of IT remediation tasks that are not necessarily the highest probability, but which have additional features indicative of a more optimal solution, or less risky solution.

Each alternative for performing operations to address an IT incident may be evaluated by the machine learning trained computer tools to identify patterns of input features and corresponding probabilities/confidence scores, for those alternatives successfully performing the corresponding operations, i.e., a degree of matching of the IT remediation task descriptions to the IT incident descriptions which is indicative of the IT remediation task being appropriate for addressing the IT incident. For example, the machine learning trained computer tools may, in some illustrative embodiments, generate scores for IT remediation tasks and corresponding skills required by the IT remediation tasks, and may evaluate these IT remediation tasks and skills with regard to minimum threshold scores, whether the skills have fallback skills, whether the skills have corresponding rollback skills, and the like, and may determine alternative skills, and if need be, alternative IT remediation tasks having alternative skills, for generating a sequence of IT remediation tasks to handle the IT incident. See again, the examples of a primary sequence Skill A->Skill B (score=0.98)->Skill C and alternative sequence Skill A->Skill D (score=0.95)->Skill C, discussed above.

Once a sequence of IT remediation tasks and their corresponding automation tools and/or SREs/SRE teams is generated to define an IT incident remediation workflow, the workflow is provided by the engine 130 to the IT remediation task execution coordination engine 140 which orchestrates the execution of the resulting sequence of IT remediation tasks for handling the IT incident. For example, the engine 140 may invoke the automated tools for performing IT remediation tasks for which there are automated tools, monitor the automated tools performance for messages specifying that the automated tool completed the IT remediation task successfully or not, and then either take alternative action if unsuccessful, or initiate the next task in the sequence providing the results of the previously executed task. In the case of tasks that are to be completed by SREs/SRE teams, automated communications 172 may be generated and transmitted to the SREs/SRE teams as specified in the SRE data, so as to initiate SRE performance of the task. Moreover, the engine 140 may monitor for responsive communications from the SREs/SRE teams indicating that they have completed the assigned IT remediation task successfully or not. If successfully completed, the engine 140 may then initiate the next task in the sequence, if there is one, and provide the results of the previously performed task(s).

If one or more tasks of the sequence are not able to be successfully performed, as noted above, the engine 140 may look for fallback or rollback tasks to perform to either rollback changes made by previous tasks, or generate alternative sequences based on fallback skills and corresponding IT remediation tasks. This determination may have the engine 140 invoke the operation of the engine 130 to look for alternatives to unsuccessfully performed IT remediation tasks, as well as the association of skills specified in the relationship graphs 170. In the case where there is no rollback and/or fallback skill and IT remediation task, then SREs/SRE teams may be automatically notified of this inability to perform the IT remediation task and request manual intervention. In the case where the sequence of the IT remediation tasks cannot be completed successfully, then an authorized user may be automatically notified of the IT incident and the IT remediation tasks that are not able to be performed successfully to remediate the IT incident.

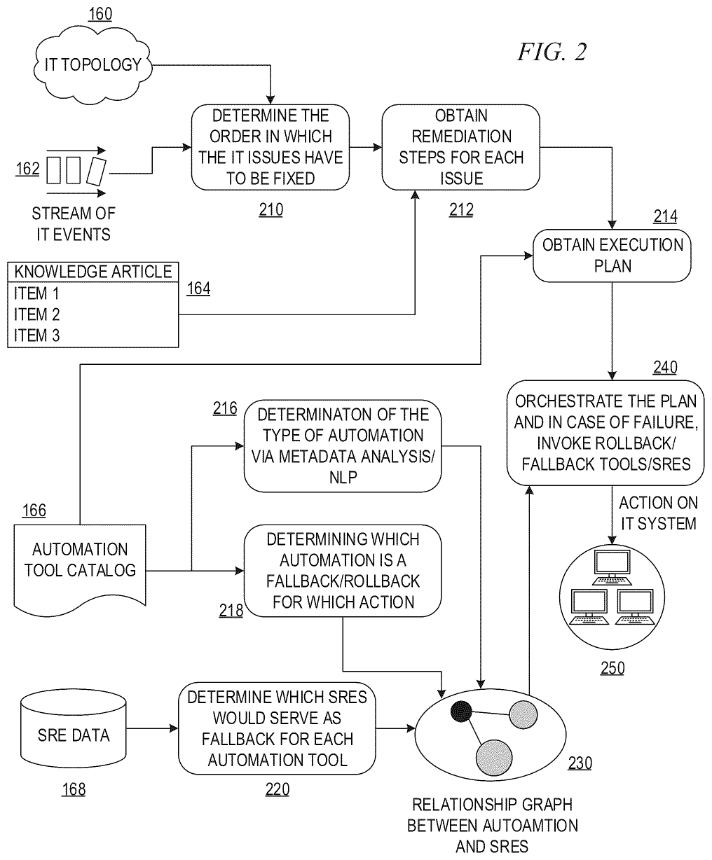

FIG. 2 is a flow diagram illustrating a process for IT incident remediation task workflow exploration in accordance with one illustrative embodiment. The flow shown in FIG. 2 is similar to that described above with regard to FIG. 1. As shown in FIG. 2, the IT topology 160 and stream of IT events/alerts are used as a basis for determining the order in which IT issues (IT events/alerts of an IT incident) are to be fixed (210). The result of this determination is used, along with the knowledge articles of the knowledge corpus 164 to identify remediation steps, i.e., remediation tasks, for each issue (212). The result of the identification of remediation steps is used along with the information in the automation catalog 166 to identify an execution plan (214), or IT remediation task workflow, comprising the ordered sequence of remediation steps and the corresponding automated tools for perform the remediation steps. It should be appreciated that these operations involve the use of the mappings, similarity analysis, and the like, described previously to match skills required by IT remediation steps and skills offered by automation tools.

The automation tools catalog 166 is also used as a basis for determining the type of automation, e.g., action/rollback/fallback/monitoring, etc. (216) and determining which automation is a fallback/rollback for each action skill (218). SRE data 168 is used as a basis for determining which SREs/SRE teams would serve as fallback for each automation tool (220). The results of these determinations are used to generate one or more relationship graph data structures 230 that identify the relationships between skills and automation tools and SREs/SRE teams. The relationship graph data structures 230 are used along with the execution plan 214 to orchestrate (240) the plan by invoking the corresponding automated tools and communicating with SREs/SRE teams to perform the IT remediation tasks and monitor their performance on the IT resources of the IT infrastructure 250.

Thus, the illustrative embodiments provide an automated improved computing tool for performing exploratory orchestration of IT incident remediation workflows, or sequences of IT remediation tasks, which may be composed of mixed methodologies of IT remediation task performance. The illustrative embodiments provide automated improved computing tools to orchestrate, monitor, and manage the performance of these IT incident remediation workflows. Thus, the illustrative embodiments are able to leverage the skills and capabilities of both automated tools and SREs/SRE teams to facilitate an optimum solution to remediating IT incidents, resulting in more efficient workflows and more efficient solutions to IT incidents. This in turn improves IT infrastructure operation and availability of IT resources.

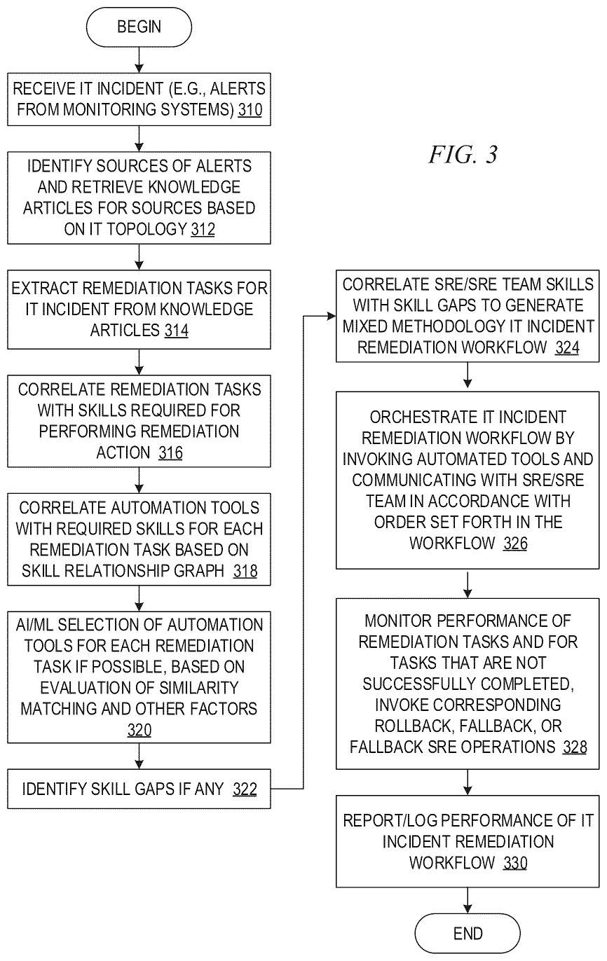

FIG. 3 is a flowchart outlining an example operation for performing IT incident remediation task workflow exploration in accordance with one illustrative embodiment. The operation outlined in FIG. 3 may be performed, for example, by an exploratory orchestration tool for IT incident remediation workflows 100 in FIG. 1, for example. It should be appreciated that while the flowchart shows the operations being performed in a designated order, the illustrative embodiments are not limited to such and the operations may be performed in a different order from that shown in FIG. 3 and many operations may be combined or performed in parallel at substantially a same time without departing from the spirit and scope of the present invention.

As shown in FIG. 3, the operation starts by receiving an IT incident notification, e.g., IT event/alerts from a monitored IT infrastructure (step 310). The sources of the IT events/alerts or affected IT resources are identified and corresponding knowledge articles for those sources are retrieved based on an IT topology (step 312). Remediation tasks for the IT incident are extracted from the retrieved knowledge articles (step 314). The remediation tasks are correlated with skills required to perform the remediation tasks (or actions) (step 316). Automation tools that provide the required skills for each remediation task are identified based on the skill relationship graph (step 318). An artificial intelligence/machine learning (AI/ML) selection of automation tools for each remediation task is performed, if possible, based on an evaluation of similarity matching and other factors, such as whether skills have corresponding fallback/rollback skills and corresponding automated tools for these fallback/rollback skills (step 320).

Skill gaps that exist, if any, are identified based on a lack of an automated tool that is able to perform a required skill for an IT remediation task (step 322). For the skill gaps, SREs/SRE teams that provide the skills of the skill gaps are identified to thereby generate a mixed methodology IT incident remediation workflow (step 324). The IT incident remediation workflow is orchestrated by invoking the automated tools and communicating with the SRE/SRE teams in accordance with the ordered sequence set forth in the workflow (step 326). The performance of the remediation tasks is monitored and for tasks that are not successfully completed, corresponding rollback, fallback, or fallback SRE operations are invoked (step 328). The results of the performance of the IT incident remediation workflow are logged/reported (step 330) and the operation terminates.

From the above discussion, it is clear that the present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides automated generation, execution, orchestration, and monitoring of IT incident remediation task workflows to address IT incidents arising in a monitored IT infrastructure. The improved computing tool implements mechanism and functionality, such as the exploratory orchestration tool for IT incident remediation workflows 100, which cannot be practically performed by human beings either outside of, or with the assistance of, a technical environment, such as a mental process or the like. The improved computing tool provides a practical application of the methodology at least in that the improved computing tool is able to automatically generate, execute, orchestrate, and monitor complex IT incident remediation task workflows which may comprise orchestrating not only automated tools, but also SREs/SRE teams in a mixed methodology workflow.

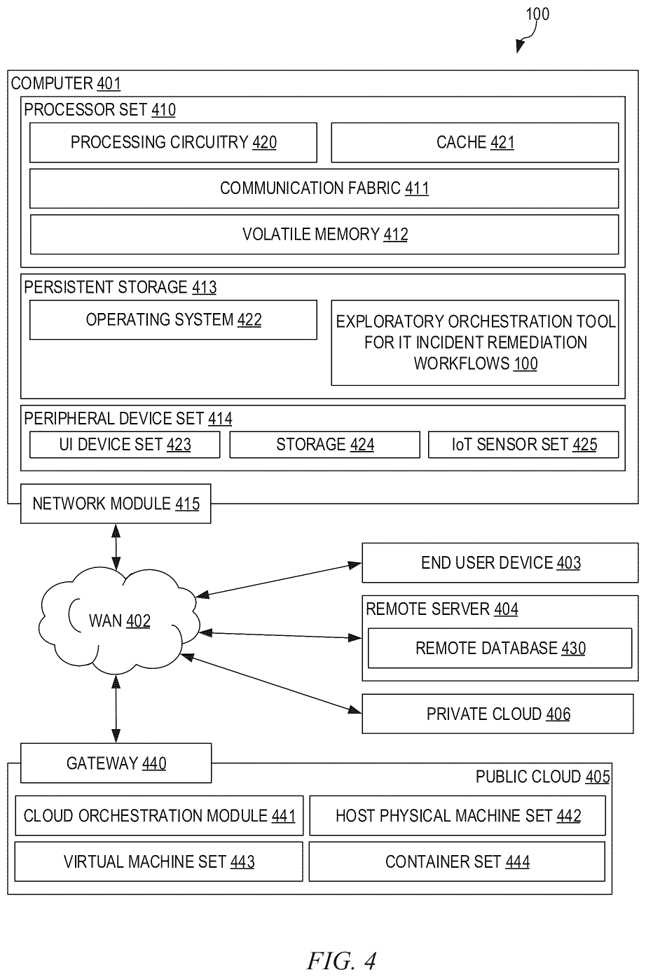

FIG. 4 is an example diagram of a distributed data processing system environment in which aspects of the illustrative embodiments may be implemented and at least some of the computer code involved in performing the inventive methods may be executed. Computing environment 400 contains an example of an environment for the execution of at least some of the computer code involved in performing the inventive methods, such as the exploratory orchestration tool for IT incident remediation workflows 100 in FIGS. 1 and corresponding flow shown in FIG. 1, for example. In addition to block 100, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 100, as identified above), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 200 in persistent storage 413.

Communication fabric 411 is the signal conduction paths that allow the various components of computer 401 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface type operating systems that employ a kernel. The code included in block 200 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

As shown in FIG. 4, one or more of the computing devices, e.g., computer 401 or remote server 404, may be specifically configured to implement an exploratory orchestration tool for IT incident remediation workflows computing system or computing tool 100, which may operate in accordance with one or more of the illustrative embodiments previously described above. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 401 or remote server 404, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments. It should be appreciated that once the computing device is configured in one of these ways, the computing device becomes a specialized computing device specifically configured to implement the mechanisms of the illustrative embodiments and is not a general purpose computing device.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

Claims

what is claimed is:

1. A method, comprising:
receiving an information technology (IT) incident notification specifying an IT incident;
retrieving at least one knowledge data structure associated with at least one IT resource, of an IT infrastructure, corresponding to the IT incident;
extracting, from the at least one knowledge data structure, one or more IT remediation tasks for handling the IT incident;
generating an IT remediation task skill set at least by identifying one or more skills in a plurality of predetermined skills that are associated with the one or more IT remediation tasks;
executing at least one first correlation operation that correlates at least one automated tool with at least one corresponding first skill in the IT remediation task skill set;
generating an IT incident remediation task workflow, comprising the one or more IT remediation tasks, based on the IT remediation task skill set and results of the at least one first correlation operation; and
automatically executing the generated IT incident remediation task workflow on the at least one IT resource.

2. The method of claim 1, further comprises executing at least one second correlation operation that correlates at least one site reliability engineer with at least one corresponding second skill in the IT remediation task skill set, wherein generating the IT incident remediation task workflow further comprises generating the IT incident remediation task workflow based on the results of the at least one second correlation operation.

3. The method of claim 2, wherein executing the at least one first correlation operation comprises identifying one or more skill gaps, wherein a skill gap is a skill in the IT remediation task skill set for which there is no automated tool that provides that skill.

4. The method of claim 3, wherein the at least one second skill is a skill associated with a skill gap, and wherein the second correlation operation is only performed with regard to skills associated with skill gaps.

5. The method of claim 3, further comprising, for each of the one or more skill gaps:
determining for a corresponding IT remediation task associated with the skill corresponding to the skill gap, whether a fallback IT remediation tasks is available that could be performed instead of that corresponding IT remediation task;
in response to determining that a fallback IT remediation task is available that could be performed instead of that corresponding IT remediation task, determining if an automated tool is available that provides a skill needed to perform the fallback IT remediation task; and
in response to determining that an automated tool is available that provides a skill needed to perform the fallback IT remediation task, replacing the corresponding IT remediation task with the fallback IT remediation task in the IT remediation task workflow and selecting the automated tool to perform the fallback IT remediation task in the IT remediation task workflow.

6. The method of claim 5, further comprising:
in response to an automated tool not being available that provides the skill needed to perform the fallback IT remediation task, performing a lookup operation in a site reliability engineer data structure based on the skill needed to perform the fallback IT remediation task; and
in response to identifying an entry for a site reliability engineer or site reliability engineering team, in the site reliability engineer data structure, that provides the skill needed to perform the fallback IT remediation task, replacing the corresponding IT remediation task with the fallback IT remediation task in the IT remediation task workflow and selecting the site reliability engineer or site reliability engineering team to perform the fallback IT remediation task in the IT remediation task workflow.

7. The method of claim 1, wherein retrieving the at least one knowledge data structure comprises identifying, from an IT topology graph data structure, the at least one IT resource, wherein the IT topology graph data structure comprises nodes corresponding to IT resources and edges representing dependencies between IT resources, and wherein the identification of the at least one IT resource comprises evaluating dependencies between IT resources associated with an IT resource corresponding to the IT incident notification based on the IT topology graph data structure.

8. The method of claim 1, wherein the at least one knowledge data structure comprises at least one natural language document, and wherein extracting one or more IT remediation tasks for handling the IT incident comprises:
executing natural language processing configured with an IT remediation task vocabulary of terms/phrases indicative of IT incidents on the at least one knowledge data structure; and
identifying an ordered sequence of IT remediation tasks based on the natural language processing of the at least one knowledge data structure.

9. The method of claim 8, wherein the at least one natural language document comprises, for each of the at least one IT resource, a corresponding knowledge article having portions describing IT incidents and portions describing IT remediation tasks for the IT incidents, and wherein the natural language processing comprises a sentence similarity processing between the IT remediation task vocabulary and the portions of the knowledge article.

10. The method of claim 1, wherein executing the first correlation operation comprises performing natural language processing of automated tool descriptions in an automated tool catalog data structure to identify skills associated with automated tools and performing a sentence similarity analysis of the automated tool descriptions with the skills in the IT remediation task skill set.

11. The method of claim 1, wherein executing the second correlation operation comprises processing one or more site reliability engineer (SRE) data structures specifying skills associated with different SREs or SRE teams and matching skills associated with different SREs or SRE teams with the IT remediation task skill set.

12. The method of claim 1, further comprising generating an IT remediation tasks knowledge graph data structure in which nodes represent IT incidents and IT remediation tasks corresponding to the IT incidents, and wherein edges link selected one of the IT remediation tasks to corresponding IT incidents with which the IT remediation tasks are associated.

13. The method of claim 12, wherein identifying one or more skills in a plurality of predetermined skills that are associated with the one or more IT remediation tasks comprises:
identifying a subset of nodes in the IT remediation tasks knowledge graph data structure that correspond to the IT incident specified in the IT incident notification; and
identifying the one or more skills based on characteristics of the subset of nodes in the IT remediation tasks knowledge graph data structure.

14. The method of claim 1, further comprising:
classifying the one or more skills in the plurality of predetermined skills as being one of a plurality of predetermined skill types, wherein the skill types comprise an action skill type, a monitor skill type, a fallback skill type, and a rollback skill type; and
generating an IT incident remediation task workflow comprises selecting, for each IT remediation task in the IT incident remediation task workflow, a corresponding automated tool or site reliability engineer based on a trained machine learning computer model that scores the at least one automated tool and at least one site reliability engineers based on results of the first correlation operation, results of the second correlation operation, a classification of skills associated with the at least one automated tool, and a classification of skills associated with the at least one site reliability engineer.

15. The method of claim 14, wherein the trained machine learning computer model scores the at least one automated tool and the at least one site reliability engineer based on a degree of matching of skills associated with the at least one automated tool and skills associated with the at least one site reliability engineer, and based on whether or not the at least one automated tool and the at least one site reliability engineer has a rollback skill or a fallback skill.

16. The method of claim 15, wherein selecting the corresponding automated tool or site reliability engineer further comprises performing an exploratory orchestration operation at least by identifying, for one or more of the IT remediation tasks in the IT incident remediation task workflow, one or more fallback tasks based on the classification of the one or more skills in the plurality of predetermined skills, and generating alternative IT incident remediation task workflows comprising the one or more fallback tasks.

17. The method of claim 1, wherein generating the IT incident remediation task workflow comprise executing a trained machine learning computer tool on input features corresponding to the IT remediation task skill set, characteristics of the automation tools from an automation tools catalog, characteristics of site reliability engineers or site reliability engineering teams from a site reliability engineering data structure, the correspondence of the at least one automated tool with the at least one corresponding first skill, and the correspondence of and the at least one site reliability engineer with the at least one corresponding second skill to score each automation tool and site reliability engineer or site reliability engineering team for performing each IT remediation task in the IT remediation task workflow.

18. The method of claim 17, further comprising selecting, for each IT remediation task in the IT remediation task workflow, at least one of an automation tool, site reliability engineer, or site reliability engineering team to perform the IT remediation task based on the scores.

19. The method of claim 1, wherein the IT incident remediation task workflow comprises at least one first IT remediation task that has an associated automated tool assigned to perform the at least one first IT remediation task, and at least one second IT remediation task that has an associated site reliability engineer or site reliability engineering team assigned to perform the at least one second IT remediation task, and wherein automatically executing the generated IT incident remediation task workflow on the at least one IT resource comprises:
for each first IT remediation task, automatically invoking the assigned automated tool to execute operations to perform the first IT remediation task and awaiting an automated response indicating completion of the first IT remediation task by the assigned automated tool; and
for each second IT remediation task, automatically transmitting an electronic communication to a computing device associated with the site reliability engineer or site reliability engineering team and awaiting a responsive communication from the computing device indicating completion of the second IT remediation task by the site reliability engineer or site reliability engineering team.

20. A computer program product comprising a computer readable storage medium having a computer readable program stored therein, wherein the computer readable program, when executed in a data processing system, causes the data processing system to:
receive an information technology (IT) incident notification specifying an IT incident;
retrieve at least one knowledge data structure associated with at least one IT resource, of an IT infrastructure, corresponding to the IT incident;
extract, from the at least one knowledge data structure, one or more IT remediation tasks for handling the IT incident;
generate an IT remediation task skill set at least by identifying one or more skills in a plurality of predetermined skills that are associated with the one or more IT remediation tasks;
execute at least one first correlation operation that correlates at least one automated tool with at least one corresponding first skill in the IT remediation task skill set;
generate an IT incident remediation task workflow, comprising the one or more IT remediation tasks, based on the IT remediation task skill set and results of the at least one correlation operation; and
automatically execute the generated IT incident remediation task workflow on the at least one IT resource.

22. The method of claim 1, wherein the at least one correlation operation further comprises at least one second correlation operation that correlates at least one site reliability engineer with at least one corresponding second skill in the IT remediation task skill set.

23. The method of claim 1, wherein executing the first correlation operation comprises identifying one or more skill gaps, wherein a skill gap is a skill in the IT remediation task skill set for which there is no automated tool that provides that skill.

24. An apparatus comprising:
at least one processor; and
at least one memory coupled to the at least one processor, wherein the at least one memory comprises instructions which, when executed by the at least one processor, cause the at least one processor to:
receive an information technology (IT) incident notification specifying an IT incident;
retrieve at least one knowledge data structure associated with at least one IT resource, of an IT infrastructure, corresponding to the IT incident;
extract, from the at least one knowledge data structure, one or more IT remediation tasks for handling the IT incident;
generate an IT remediation task skill set at least by identifying one or more skills in a plurality of predetermined skills that are associated with the one or more IT remediation tasks;
execute at least one first correlation operation that correlates at least one automated tool with at least one corresponding first skill in the IT remediation task skill set;
generate an IT incident remediation task workflow, comprising the one or more IT remediation tasks, based on the IT remediation task skill set and results of the at least one correlation operation; and
automatically execute the generated IT incident remediation task workflow on the at least one IT resource.

25. A method, comprising:
receiving an information technology (IT) incident notification specifying an IT incident;
retrieving at least one knowledge data structure associated with at least one IT resource, of an IT infrastructure, corresponding to the IT incident;
extracting, from the at least one knowledge data structure, one or more IT remediation tasks for handling the IT incident;
generating an IT remediation task skill set at least by identifying one or more skills in a plurality of predetermined skills that are associated with the one or more IT remediation tasks;
executing at least one first correlation operation that correlates at least one automated tool with at least one corresponding first skill in the IT remediation task skill set;
identifying a skill gap based on results of the at least one first correlation operation, wherein the skill gap is a skill in the IT remediation task skill set for which there is no automated tool that provides that skill;
associating, with the skill gap, an entity to satisfy criteria of the skill gap;
generating an IT incident remediation task workflow, comprising the one or more IT remediation tasks, based on the IT remediation task skill set, results of the at least one first correlation operation, and results of associating the entity to the skill gap; and
automatically executing the generated IT incident remediation task workflow on the at least one IT resource using the at least one automated tool and the associated entity.
